(19) United States
(12) Patent Application Publication
(10) Pub. No.: US 2009/0152359 A1
(43) Pub. Date: Jun. 18, 2009

(54) Methods and Apparatus for Signals Exhibiting Improved Signal to Noise Ratio in Image Bar Code Scanning

(76) Inventor: Sik Piu Kwan, Suwanee, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/957,637

(22) Filed: Dec. 17, 2007

(51) Int. Cl. G06K 7/10

(52) U.S. Cl. 235/462.12

(57) ABSTRACT

Systems and techniques for improved imaging scanning. An imaging bar code scanner uses an imaging device to capture a bar code image, and combines multiple rows of image information. An image of a typical bar code will comprise multiple rows of similar or identical visual information so that the multiple rows of image information will include repetitions of the same image information, with differing or cancelling noise information. The combined information is processed to generate a scan signal, which will exhibit a higher signal to noise ratio compared to a scan signal based on a single row of image information. The scan signal can be analyzed to identify transitions between light and dark areas of the bar code.

### FIELD OF THE INVENTION

The present invention relates generally to improvements to bar code scanning. More particularly, the invention relates to improved systems and techniques for capturing and processing a bar code image so as to generate a scan signal exhibiting a signal to noise ratio sufficient for accurate and efficient scanning.

### BACKGROUND OF THE INVENTION

Retail checkout operations, have used bar code scanning for many years, and bar code scanning has proven to be of great value in numerous other applications as well. Improved efficiency and accuracy of bar code scanning typically leads to improved efficiency of operations in which such scanning is used. One promising bar code scanning technology is imaging scanning, involving the capture and processing of a visual image of a bar code by an imaging device such as a digital camera, in order to extract bar code information. One important aspect of imaging scanning, and of all bar code scanning, is the signal to noise ratio of any signal that is processed to identify light and dark regions of a bar code. The signal produced by processing an image of a bar code typically comprises positive and negative peaks which are analyzed to indicate transitions between light and dark regions. Noise affecting the signal may cause unpredictable effects on the signal level, and may impair the recognition of transitions by decreasing peaks.

Image scanning is subject to a number of constraints. Frequently, it is desired to perform bar code scanning by moving objects bearing bar codes past scanning devices, in order to achieve a rapid throughput of scanned items. This procedure is often used, for example, in retail checkout operations. If image scanning is performed by moving a bar through the field of view of an imaging device, such as a digital camera, the captured image is subject to blurring. In order to reduce or eliminate blurring, it is desirable to use a fast shutter speed. However, the use of a fast shutter speed reduces the light reaching the camera, unless a strong illumination is used. Such strong illumination is often impractical or impossible, because it is unacceptably hazardous or uncomfortable to an operator or bystander. Using a fast shutter speed together with a lower illumination than might ideally be desirable for such a shutter speed, may result in a dark, low contrast image.

### SUMMARY OF THE INVENTION

Among its several aspects, the present invention recognizes that the circumstances under which imaging scanning is frequently performed may result in the capture of a dark, low contrast image, and that processing of this image to yield a bar code signal is likely to produce a signal subject to noise. The invention addresses such problems, as well as others, by processing multiple rows of sensors in a captured bar code image. A digital image as typically captured by an image sensor, such as a charge coupled device (CCD), complementary metal oxide semiconductor (CMOS), or other image sensor such as may be used in digital imaging systems such as digital cameras, comprises information captured by an array of sensor elements making up the sensor. The information captured by each sensor element may be referred to as a pixel, so that the information captured by the array of sensor elements may be referred to as an array of pixels, with each pixel representing information relating to a point on the image, such as brightness and color. A bar code image may be considered as an array of image information comprising multiple rows of pixels, with each row of pixels comprising captured information representing a cross section of the bar code.

A bar code is typically a set of vertical light and dark regions, resembling vertical stripes, so that each horizontal row of pixels of such an image captures essentially the same information as relates to the transitions between light and dark bar code regions. Therefore, examining multiple rows of pixels will return multiple instances of the same information. Each row of pixels will be affected by whatever noise is present, but noise is random, and can therefore be expected to affect different rows of pixels in different ways. If noise effects tend to have an equal chance of falsely increasing or diminishing a signal, the effects of noise on different rows will tend to cancel one another as the number of rows examined increases. Also, any anomalies present in one row will tend to be diminished in effect as the information from multiple rows is added or averaged together.

A system according to an aspect of the present invention therefore processes multiple rows of pixels representing information from a bar code image, so that information provided by the processing can then be combined. Depending on the particular technique employed, combining information can be accomplished during imaging itself, or by taking information produced by the camera and combining the information mathematically, through addition, averaging, or another suitable technique. The information generated through the processing of the multiple rows produces a scan signal that can be analyzed to extract bar code information, for example, by analyzing peaks and valleys to identify transitions.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a checkout system employing a scanner according to an aspect of the present invention;

FIG. 2 illustrates a bar code that may advantageously be scanned according to an aspect of the present invention;

FIG. 3 illustrates a diagram of an imager and image processing elements employed by a scanner according to an aspect of the present invention;

FIG. 4 illustrates exemplary results showing scan signals produced by analyzing various numbers of rows of pixels according to an aspect of the present invention;

FIG. 5 illustrates a bar code at an angle to vertical relative to an imager, that may advantageously be scanned according to an aspect of the present invention;

FIGS. 6-8 illustrate groupings of pixels that may be combined according in various arrangements so as to advantageously provide for imaging scanning for bar codes at various angles to an imager, according to an aspect of the present invention;

FIG. 9 illustrates a process of image scanning according to an aspect of the present invention; and

FIG. 10 illustrates an alternative process of image scanning according to an aspect of the present invention.

### DETAILED DESCRIPTION

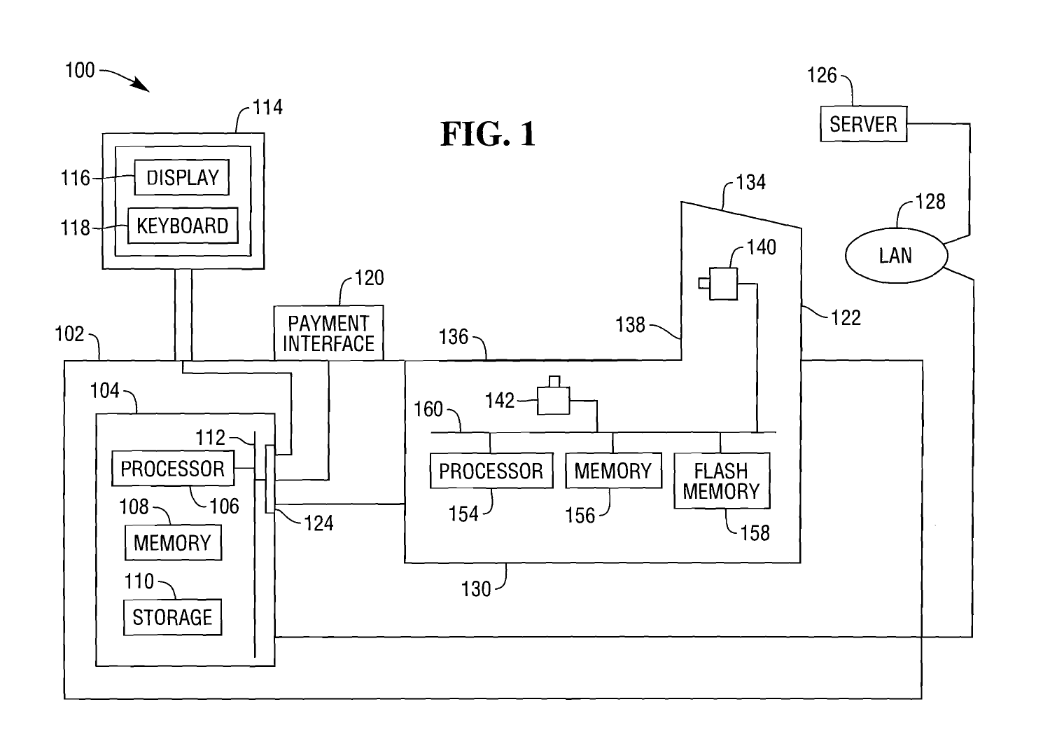

FIG. 1 illustrates a checkout system 100 according to an aspect of the present invention. The system 100 includes a point of sale terminal 102, suitably including a computer 104. The computer 104 may suitably include a processor 106, high speed memory 108, long term storage 110, all communicating over a bus 112. The terminal 102 may employ a user interface 114, including a keyboard 116 and display screen 118. The user interface 114, as well as a payment interface 120, and scanner/scale combination 122, communicate with the computer 104 through one or more interface connections, such as the exemplary interface 124. The interface 124 may suitably be a set of universal serial bus (USB) ports, a combination of USB ports and other types of ports, or any other combination of communication connectors suitable to the context and environment in which the system 100 is to be employed. The computer 104 may communicate with a central server 126 over a local area network 128.

The scanner 122 suitably includes a base 130, a tower section 134, and horizontal and vertical scan windows 136 and 138. The scanner 122 also includes imaging devices, such as digital cameras 140 and 142, and elements for control and image processing, suitably including a processor 154, memory 156, and long term storage such as flash memory 158. The processor 154, memory 156, and long term storage 158, as well as the digital cameras 140 and 142, suitably communicate over a bus 160.

Scanning is often conducted by passing objects in rapid sequence past the horizontal scan window of a scanner, which is the window 136 in the present example, although such rapid scanning may also be employed using a vertical scan window, or both a horizontal and a vertical scan window, as shown in FIG. 1. In order to achieve efficient throughput, it is highly advantageous to provide a scanner with the capability to scan items as quickly as a customer in a self-checkout environment or an employee operator in an assisted checkout environment wishes to present them to the scan window, rather than to force the human user to slow down his or her operation in order to accommodate the limitations of the scanner.

In cases where rapid scanning of moving bar codes by an imaging scanner is desired, it is highly desirable that images captured by the scanner be as free of distortion as possible. Taking images of moving objects introduces blur, unless proper steps are taken to prevent blurring. In order to eliminate or minimize blur, a fast shutter speed is advantageously used, and for the comfort and safety of persons conducting scanning or near the scanning station, excessive levels of illumination are inadvisable. Therefore, a bar code image captured under such circumstances tends to be significantly affected by noise. Therefore, a scanner such as the scanner 122 suitably processes captured images in such a way as to overcome or compensate for the effects of noise, by taking advantage of the fact that a typical bar code includes multiple instances of essentially identical information. In the present exemplary embodiment, the scanner 122 processes a bar code image by combining information from multiple rows of pixels representing elements of a bar code image and processing the combined information to produce a scan signal.

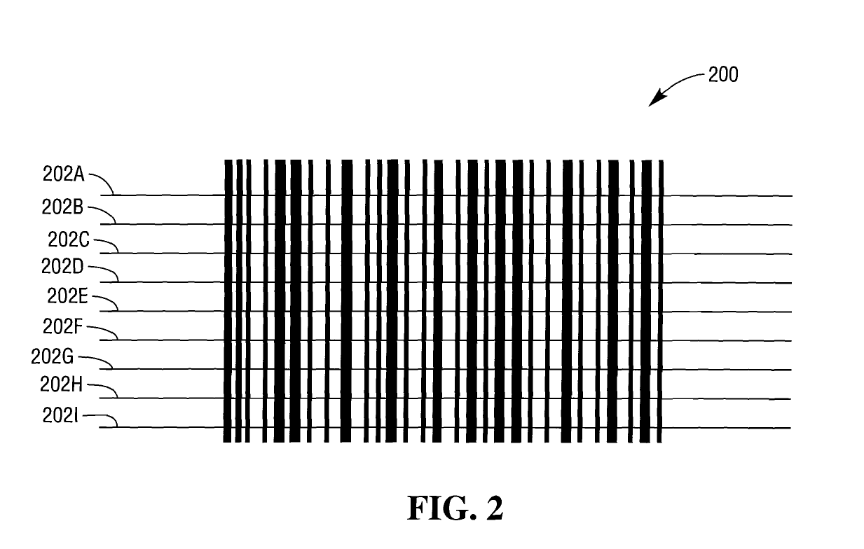

FIG. 2 illustrates an image of a bar code 200 that may advantageously be scanned using systems and techniques of an aspect of the present invention. The bar code 200 is an interleaved 2 of 5 bar code representing the numerical sequence 0123456789. The bar code 200 comprises alternating dark and light areas. When the bar code 200 is oriented vertically, the dark and light areas can be seen to be identical along their vertical extent. If an image of the bar code 200 is thought of as comprising one or more rows of pixels, the bar code image can provide numerous essentially duplicate rows, which can be combined as desired to eliminate or minimize extraneous effects, such as noise.

The dashed lines 202A-202T represent rows passing through the bar code 200. Any image of the bar code 200, or any similar bar code, will provide numerous rows of information. A scanner according to an aspect of the present invention, such as the scanner 122, can implement any of various alternative means of selecting and processing rows of information in an image.

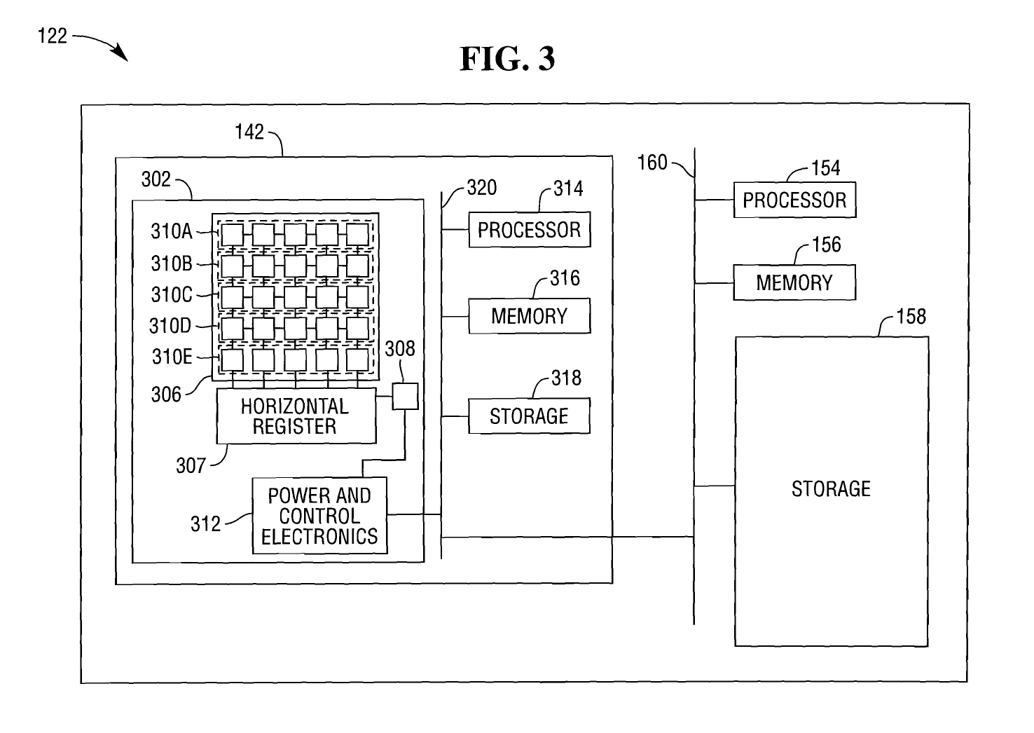

FIG. 3 illustrates image capture and processing elements of a scanner such as the scanner 122. The elements are shown in block diagram form, and include stored software used in processing. The digital camera 142 can be seen, as can the processor 154, memory 156, long term storage 158, and bus 160. The digital camera 144 is not illustrated here, in order to avoid repetitive description, but suitably operates in a way similar to that of the camera 142 discussed below.

The camera 142 includes an imaging device 302, which may take the form of a charge coupled device (CCD), CMOS sensor device, or other suitable device. The imaging device 302 comprises an array 306 of individual cells, a horizontal register 307, and a bus 308. The array comprises numerous cells, but for simplicity, the imaging device 302 will be represented for illustrative purposes as comprising 25 cells arranged in rows 310A-310E. The imaging device 302 also suitably includes a power and electronic control package 312. These elements may all reside on a single chip. When light strikes the imaging device 302, charges accumulate in the cells of the array 306. In order to retrieve visual information from the array 306, charges are allowed or induced to migrate vertically to the horizontal register 307, and then to the bus 308.

Many imaging devices implement a binning feature, in which charges in adjacent rows may be combined. Rather than passing each row individually to the horizontal register 307, and then passing the charges out of the horizontal register 307 to the bus 308 before the next row is passed to the horizontal register, charges from one row may be passed to an adjacent row so as to produce a row of combined charges. This row of combined charges may then be passed to another adjacent row, and so on. Combinations of adjacent rows may be achieved as desired, with any desired grouping of rows capable of being implemented. For example, the rows 310D and 310E may be combined and passed to the horizontal register 307 and out the bus 308, the row 310C may be passed to the horizontal register 307 and out the bus 308 individually, and the rows 310B and 310A may be combined and passed to the horizontal register 307 and out the bus 308. In a larger array, a large number of alternative groupings is possible.

Such binning allows the row data to be combined within the imaging device 302, so that digitizing and processing may be performed on the already combined data. The imaging device 302 may be chosen and configured to implement such a binning feature in order to combine multiple rows, so that the image information passed to the bus 308 during bar code scanning may represent a combination of multiple rows, combined in the array 306 before being passed to the bus 308. The information received from the imaging device 302 will thus inherently represent combined information from multiple rows.

As an alternative to combining data using a binning feature of an imaging device such as the imaging device 302, it is also possible to combine information from multiple rows mathematically during data processing. Charge data from each row of cells of the array 306 is passed to the horizontal register and out to the bus. Data from the entire array of cells is thus available for processing. Processing of the data includes selecting a specified number of rows of pixels, taking information from those rows of pixels, and combining the information using predetermined techniques, such as addition or averaging.

Such processing may be performed by the power and electronic control package 312 on the imaging device 302, or elsewhere within the camera 142, which suitably includes its own processor 314, memory 316, and storage 318, communicating over a bus 320, which can in turn be connected to the bus 160. If desired, the camera 142 may be provided without its own storage 318, using the storage 158 of the scanner 122 instead. The camera 142 performs appropriate processing as discussed herein in order to retrieve data from the imaging device 302, and passes the data to the bus 160 of the scanner 122.

As a further alternative, mathematical combining of row data may be performed elsewhere in the scanner 122, in generating a scan signal to be interpreted by the scanner.

The scanner 122 uses the data received from the imaging device 302 to create a scan signal which, because of the combining of multiple instances of essentially the same information from multiple rows of pixels of the bar code image, exhibits a greater signal to noise ratio than a signal based on a single row of pixels.

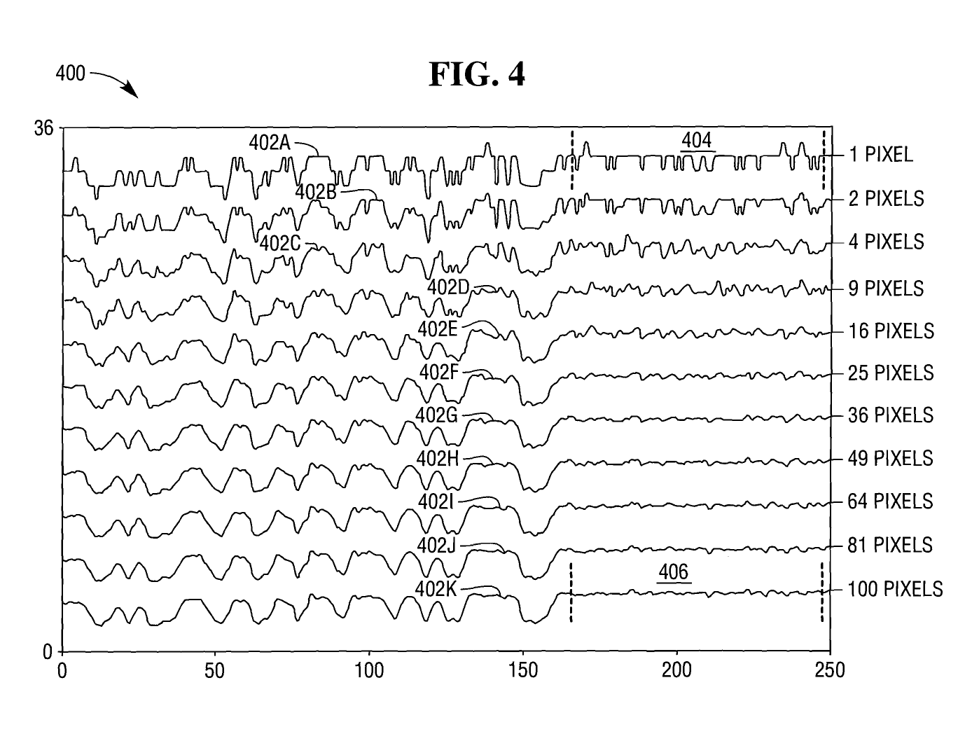

FIG. 4 illustrates a graph 400 showing a set of exemplary data for image scans of a bar code, showing scan signals based on increasing numbers of rows of pixels. The curves 402A-402K illustrate scan signals based on 1, 2, 4, 9, 16, 25, 36, 49, 64, 81, and 100 rows of pixels, respectively. It can be seen that the curve 402A is so severely affected by noise as to be unusable because of the presence of numerous false peaks, and deviation of peaks from the more accurate representations provided by curves based on greater numbers of rows. Notably, the rightmost regions of the curves based in larger numbers of pixels, for example, the region 406 of the curve 402K, is nearly flat, indicating that the portion of the image on which they are based is unvarying, but the corresponding region 406 of the curve 402A includes numerous peaks, so that processing the signal represented by the curve 402A would produce a number of false transitions in that region. As the number of rows increases, the number of false peaks decreases, reflecting a decreasing influence of noise, as noise peaks from multiple rows tend to cancel one another out.

It will be noted that the curve 402A exhibits noticeable diminution of the amplitudes of spurious peaks, showing the effect of combining 2 pixels, and that these peaks are even further reduced in the curve 402C, showing the effects of combining 4 pixels. A combination of 2 to 4 rows can be expected to produce significant improvement, allowing reliable scanning for bar codes in which the narrowest segment is 0.01 inch, with a combination of 8 rows being expected to allow for reliable scanning for bar codes in which the narrowest segment is 0.005 inch. These combinations can typically he achieved without an unacceptable reduction in the speed of passby scanning.

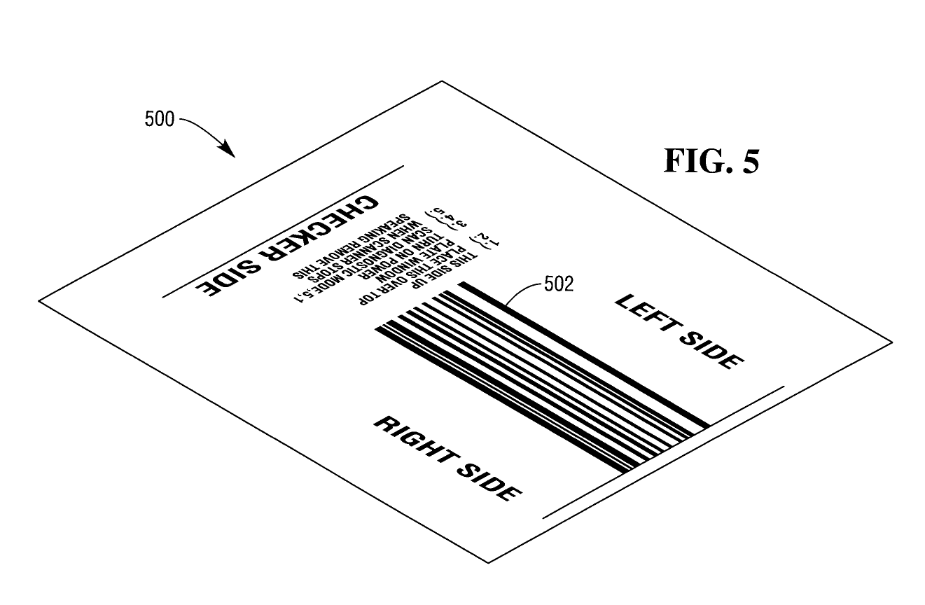

An imaging device such as that the digital camera 142 illustrated in FIGS. 1 and 3 can also be used to combine information from multiple rows of pixels captured when a bar code is varied from a vertical orientation, such as that illustrated in FIG. 2. FIG. 5 illustrates a captured image 500 of a bar code 502, captured when the bar code 502 is at a 45 degree orientation from vertical. In order to provide a signal with an increased signal to noise ratio, multiple rows may be combined, but the pixels to be combined in each row should follow the orientation of the bar code.

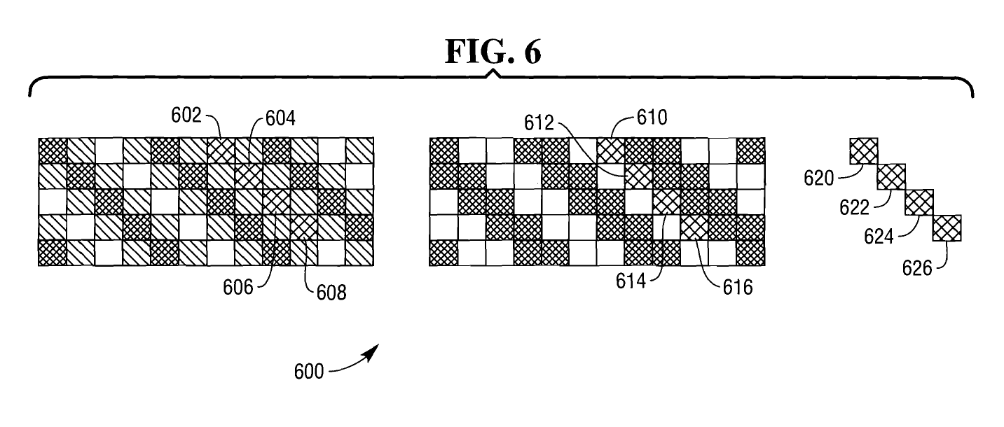

FIG. 6 illustrates a partial pixel array 600, representing information that would be present in a captured image similar to the image 500 of FIG. 5. The numbered pixels 602, 604, 606, and 608 represent pixels situated at the midpoint of a light region within the bar code, and the numbered pixels 610, 612, 614, and 616 represent pixels situated near the edge of a light region within the bar code. The pixels to be combined fall in the geometry shown by the pixels 620, 622, 624, and 626. Each row of pixels of the partial array 600 includes an image of the bar code, but the pixels to be combined are shifted down and to the right with respect to pixels that would be in an image of a bar code at a vertical orientation.

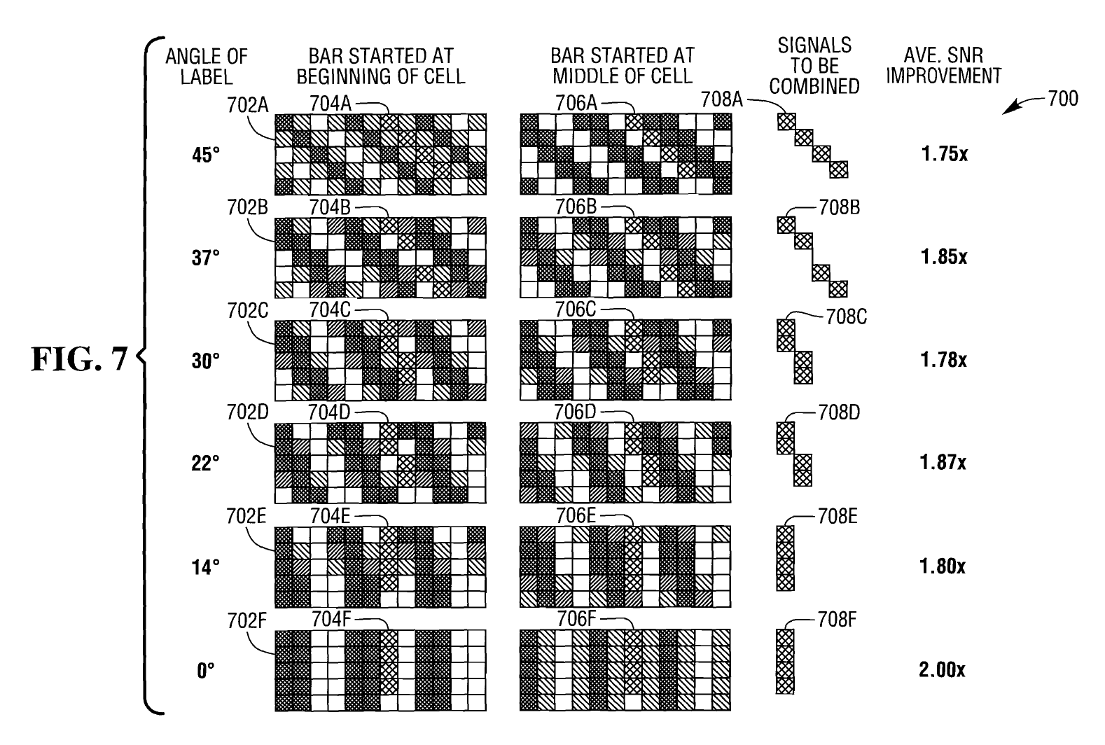

FIG. 7 is a diagram 700 illustrating a sequence of partial arrays of pixels 702A-702F, showing pixels of interest that should be combined when a bar code is in various orientations from the vertical. The pixel groupings 704A-704F illustrate various groupings of pixels of interest for one line of the bar code at various orientations, namely 45, 37, 30, 22, 14, and 0 degrees from vertical, and the groupings 706A-706F illustrate various groupings of pixels of interest of another line of the pixels at the same orientations. The groupings 708A-708F show the combinations to be made. In each case, the combination yields a significant improvement in signal to noise ratio. It will be noted that in the ease of bar codes differing from a vertical orientation, the pixels to be combined are not adjacent in every case. In the example presented here, a row is skipped for the 37 degree orientation.

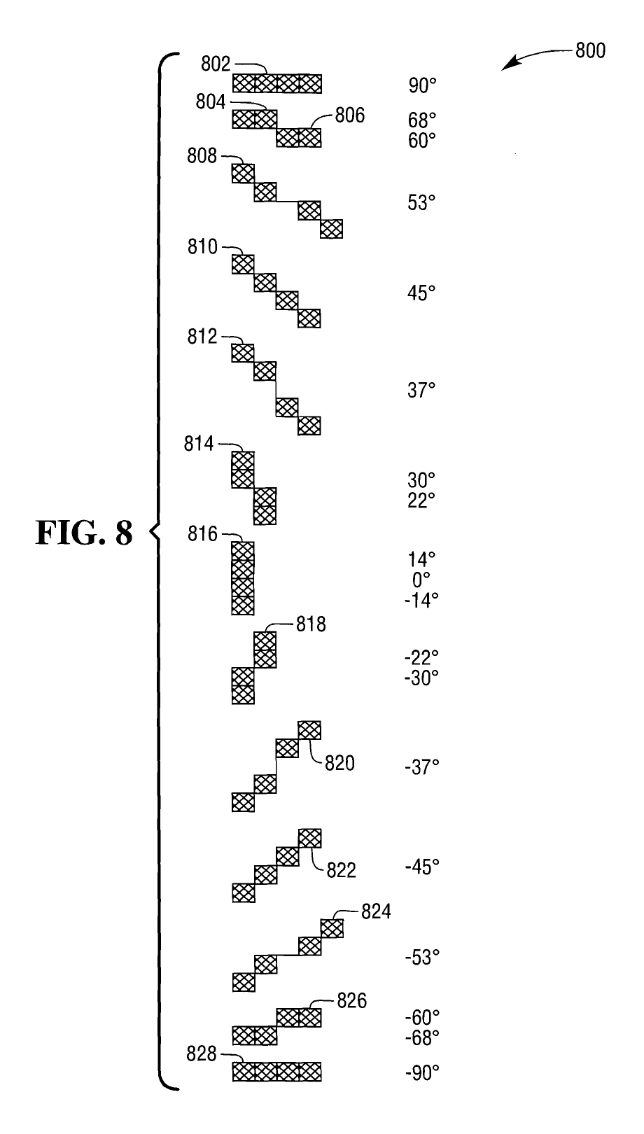

FIG. 8 is a diagram 800 illustrate the pixel groupings that should be made at various orientations. The pixel groupings 802-828 represent combinations for the orientations of 90, 68 and 60, 53, 45, 37, 30 and 22, 14, 0, and −14, −22 and −30, −37, −45, −53, −60 and −68, and −90 degrees from vertical, respectively. It will be noted that various shifts and skips are made to accommodate the particular positions in which pixels of interest are put at the various orientations. For example, a horizontal skip is needed for the 53 degree orientation, and a vertical skip is needed for the 37 degree orientation. For each orientation, proper adjustments are made by the imaging device 302 or other processing elements of the camera 142 or scanner 122, in order to achieve the proper combinations.

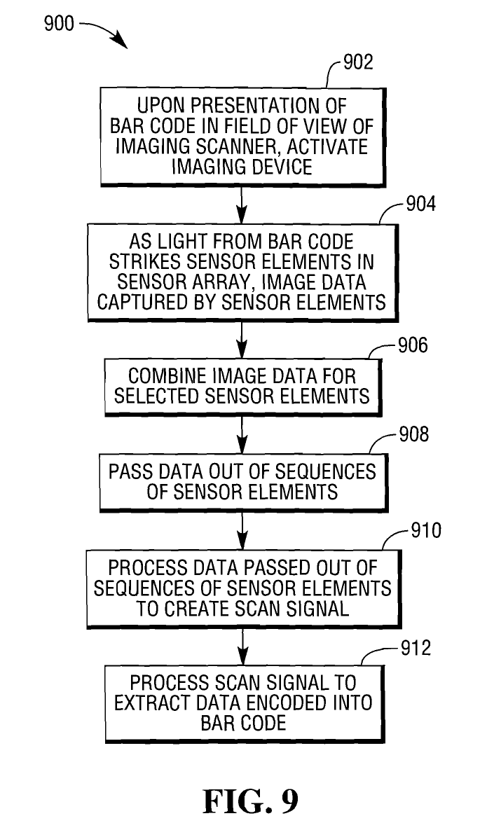

FIG. 9 illustrates a process 900 of image scanning of a bar code. At step 902, upon presentation of a bar code in the field of view of an imaging scanner, an imaging device is activated. Alternatively, the imaging device may be continuously active. At step 904, as light reflected from the bar code image strikes sensor elements in a sensor array in the image device, image data is captured by the sensor elements. At step 906, image data for selected sensor elements is combined. At step 908, data is passed out of sequences of sensor elements, such as rows or columns, suitably to a bus. At step 910, the data that is passed out of the sequences of sensor elements is processed to create a scan signal. At step 912, the scan signal is processed to extract data encoded into the bar code.

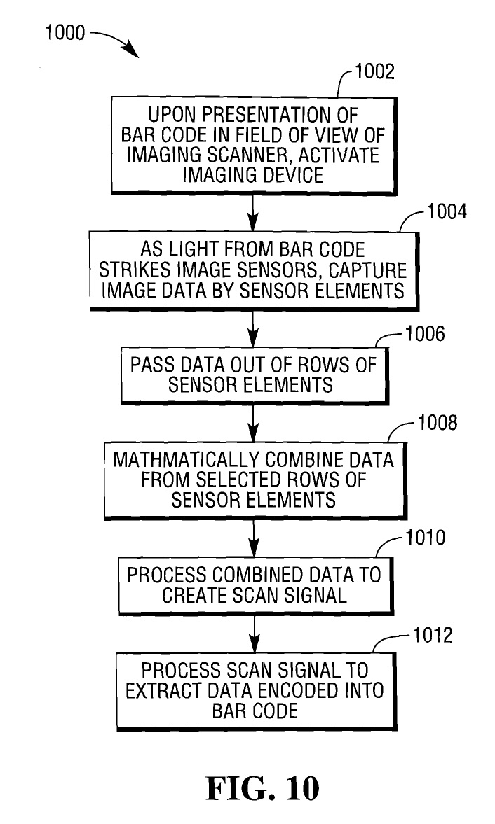

FIG. 10 illustrates an alternative process 1000 of image scanning of a bar code. At step 1002, upon presentation of a bar code in the field of view of an imaging scanner, an imaging device is activated. Alternatively, the imaging device may be continuously active. At step 1004, as light reflected from the bar code image strikes image sensor elements in a sensor array in the image device, image data is captured by the image sensor elements. At step 1006, data is passed out of sensor elements in rows. At step 1008, image data from multiple selected rows of image sensor elements is mathematically combined, for example, through addition, averaging, or another suitable operation or combination of operations. At step 1010, the combined data is processed to create a scan signal. At step 1012, the scan signal is processed to extract data encoded into the bar code.

While the present invention is disclosed in the context of a presently preferred embodiment, it will be recognized that a wide variety of implementations may be employed by persons of ordinary skill in the art consistent with the above discussion and the claims which follow below.

I claim:

1. An imaging bar code scanner, comprising:
an image capture device for capturing an image of a bar code, the image capture device being operative to store information in a sensor comprising multiple sensor elements arranged in an array of rows and columns; and
a processor for producing a scan signal based on combined information from multiple sensor elements, the combined information representing information from multiple rows of sensor elements, each row of sensor elements having stored information representing a cross section of the bar code, the processor being further operative to process the scan signal to extracted information encoded by the bar code.

2. The scanner of claim 1, wherein the combined information is generated by combining information from sensor elements appearing in multiple rows in the array and passing information representing combined values related to multiple rows of sensor elements out of the array to a bus of the imaging device.

3. The scanner of claim 1, wherein the combined information is generated by passing information from multiple rows of sensor elements out of the array and mathematically processing information from multiple selected rows so that the combined information represents a mathematical combination of a plurality of rows.

4. The scanner of claim 2, wherein the values related to the multiple rows of sensor elements comprise values related to levels of combined charges from the multiple rows of sensor elements, and wherein charges from multiple adjacent rows of sensor elements are combined in the sensor device, information related to levels of combined charges being digitized before being passed out of the sensor device.

5. The scanner of claim 4, wherein the sensor device is a charge coupled device

6. The scanner of claim 2, wherein the sensor device is a complementary metal oxide semiconductor (CMOS) sensor device and wherein the values related to the multiple rows of sensor elements are combined in the sensor device, before being passed out of the imaging device.

7. The scanner of claim 6, wherein the information related to each sensor element is digitized before being passed out of the CMOS sensor device.

8. A method of imaging bar code scanning, comprising the steps of:
capturing a digital image of a bar code;
combining rows of information of the captured image, each row representing a cross section of the bar code;
processing the combined rows of information to generate a scan signal; and
processing the scan signal to extract information encoded into the bar code.

9. The method of claim 8, wherein processing the scan signal includes analyzing the scan signal to identify positive and negative peaks indicating transitions between light and dark areas of the bar code.

10. The method of claim 9, wherein combining the rows of information comprises binning multiple rows of charges captured by a sensor device.

11. The method of claim 9, wherein the sensor device is a complementary metal oxide semiconductor (CMOS) device.

12. The method of claim 8, wherein combining the rows of information comprises mathematically combining selected rows of image information.

13. The method of claim 10, wherein binning the adjacent rows of charges is followed by digitizing information representing combined charge levels for elements in the adjacent rows of charges, passing the digitized information out of the imaging device, and processing the digitized information to generate a scan signal.

14. The method of claim 10, wherein combining the rows of information is preceded by steps of digitizing information relating to charge levels stored in sensor elements in a sensor device and passing the digitized information out of the imaging device.

15. The method of claim 14, wherein the sensor device is a complementary metal oxide semiconductor (CMOS) device.
